(19) United States
(12) Patent Application Publication
(10) Pub. No.: US 2013/0044890 A1
(43) Pub. Date: Feb. 21, 2013

(54) INFORMATION PROCESSING DEVICE, INFORMATION PROCESSING METHOD AND PROGRAM

(71) Applicants: Nobuyuki KIHARA, Tokyo (JP); Yohei SAKURABA, Kanagawa (JP)

(72) Inventors: Nobuyuki KIHARA, Tokyo (JP); Yohei SAKURABA, Kanagawa (JP)

(73) Assignee: Sony Corporation, Tokyo (JP)

(21) Appl. No.: 13/553,077

(22) Filed: Jul. 19, 2012

(30) Foreign Application Priority Data
Aug. 15, 2011 (JP) 2011-177568

(51) Int. Cl. H04B 3/20

(52) U.S. Cl. 381/66

(57) ABSTRACT

n information processing device includes: an estimating section which estimates an amplitude frequency function from a first signal output to a speaker and a second signal input from a microphone; a generating section which generates an estimated echo signal from the first signal and the amplitude frequency function; and a suppressing section which suppresses the estimated echo signal from the second signal, wherein the estimating section changes a coefficient of the amplitude frequency function on the basis of the correlation between the estimated amplitude frequency function and a short-time average amplitude frequency function.

### FIELD

The present disclosure relates to an information processing device, an information processing method and a program, and more particularly, to an information processing device, an information processing method and a program which rapidly suppresses an echo component.

### BACKGROUND

In a television conference system, communication is performed between a first device and a second device. When a sound of the other party (that is, sound transmitted from the second device) is emitted from a speaker in the first device, this sound may be collected by a microphone and may be transmitted to the other party (that is, the second device). In this case, a so-called echo phenomenon occurs.

In order to suppress this echo phenomenon, various proposals have been made (for example, JP-A-2004-56453).

In a technique disclosed in JP-A-2004-56453, one of signals obtained by subtracting an output signal of a linear echo canceller from an output signal of a microphone or an output signal of a speaker corresponds to a first signal, and the output signal of the linear echo canceller corresponds to a second signal. An estimated value of leakage of an echo is calculated from the first signal and the second signal for each frequency component of the first and second signals, on the basis of a sound detection signal which indicates the presence or absence of a near end sound. Then, the first signal is corrected based on the calculated estimated value, and thus, a near end signal in which an echo component is removed from the first signal is generated.

### SUMMARY

However, in the proposed technique, in a case where the output level of sound is changed, it takes time to sufficiently suppress the echo component.

Accordingly, it is desirable to provide a technique which is capable of rapidly suppressing an echo component.

An embodiment of the present disclosure is directed to an information processing device including: an estimating section which estimates an amplitude frequency function from a first signal output to a speaker and a second signal input from a microphone; a generating section which generates an estimated echo signal from the first signal and the amplitude frequency function; and a suppressing section which suppresses the estimated echo signal from the second signal, wherein the estimating section changes a coefficient of the amplitude frequency function on the basis of the correlation between the estimated amplitude frequency function and a short-time average amplitude frequency function.

In a case where the correlation is higher than a threshold value which is determined in advance, the coefficient may be changed by a constant value.

In a case where the correlation is lower than the threshold value, the coefficient may be not changed.

The first signal may be a signal in a frequency domain of a signal output to the speaker, and the second signal may be a signal in the frequency domain of a signal input from the microphone.

The information processing device may further include a calculating section which calculates an instant amplitude frequency function from the first signal and the second signal in the frequency domain, and the estimating section may estimate the amplitude frequency function from the instant amplitude frequency function.

The second signal in the frequency domain, in which the estimated echo signal is suppressed, may be converted into a signal in a time domain.

Another embodiment of the present disclosure is directed to a method and a program which correspond to the information processing device according to the embodiment of the present disclosure.

In the embodiment of the present disclosure, the amplitude frequency function is estimated from the first signal output to the speaker and the second signal input from the microphone; the estimated echo signal is generated from the first signal and the amplitude frequency function; the estimated echo signal is suppressed from the second signal, and the coefficient of the amplitude frequency function is changed on the basis of the correlation between the estimated amplitude frequency function and the short-time average amplitude frequency function.

As described above, according to the embodiments of the present disclosure, it is possible to rapidly suppress an echo component.

### BRIEF DESCRIPTION OF THE DRAWINGS

FIG. 1 is a block diagram illustrating a configuration of an information processing system according to an embodiment of the present disclosure;

FIG. 2 is a block diagram illustrating a configuration of an adaptive echo subtracter;

FIG. 3 is a block diagram illustrating a configuration of an amplitude frequency function estimating section;

FIG. 4 is a flowchart illustrating an output process of a first information processing device;

FIG. 5 is a flowchart illustrating an input process of the first information processing device;

FIG. 6 is a flowchart illustrating an amplitude frequency function estimating process;

FIG. 7 is a diagram illustrating a specific example of an update coefficient;

FIG. 8 is a diagram illustrating the outline of an operation of the information processing system;

FIG. 9 is a diagram schematically illustrating the operation of the information processing system;

FIG. 10 is a block diagram illustrating a compared configuration of the amplitude frequency function estimating section;

FIG. 11 is a diagram schematically illustrating the operation of a compared information processing system; and

FIG. 12 is a block diagram illustrating a configuration example of a personal computer.

### DETAILED DESCRIPTION

Hereinafter, an embodiment for implementing the present disclosure will be described, and description will be made in the following order.

1. Configuration of Information Processing System

2. Operation of Information Processing System

3. Conceptual Description about Operation

4. Application of the Present Disclosure to Program

5. Others

### <1. Configuration of Information Processing System>

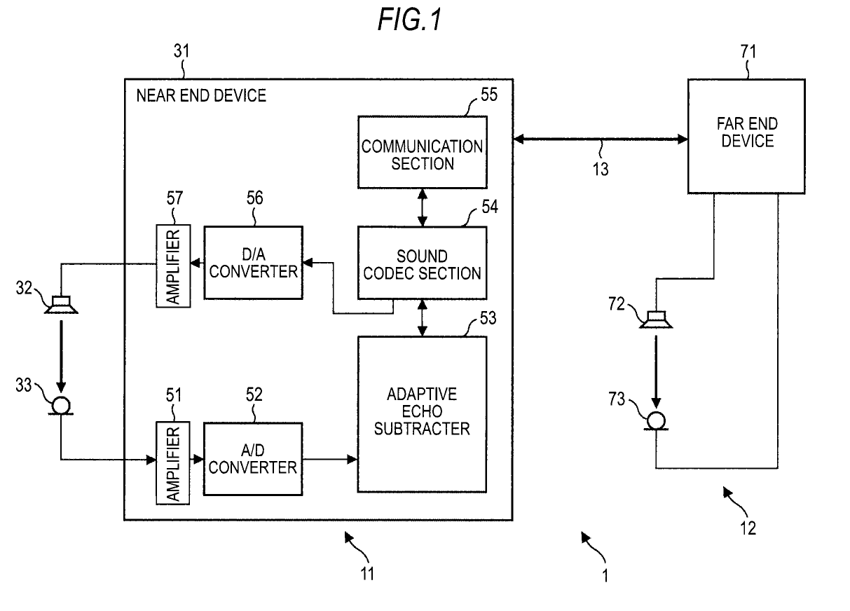

FIG. 1 is a block diagram illustrating a configuration of an information processing system 1 according to an embodiment of the present disclosure.

For example, an information processing system 1 which forms a television conference system includes a first information processing device 11, a second information processing device 12, and a communication line 13 which connects the first information processing device 11 and the second information processing device 12. The communication line 13 is a communication line through which digital communication can be performed, such as an Ethernet (trademark), for example. The communication line 13 may include a network such as the Internet and others. In the information processing system 1, a configuration relating to image signal processing is omitted.

The first information processing device 11 includes a near end device 31, a speaker 32, and a microphone 33.

The near end device 31 includes an amplifier 51, an A/D converter 52, an adaptive echo subtracter 53, a sound codec section 54, a communication section 55, a D/A converter 56, and an amplifier 57.

The microphone 33 receives as an input a sound of a user of the first information processing device 11. The amplifier amplifies the input from the microphone 33. The amplification factor of the amplifier 51 may be set and changed to an arbitrary value as the user adjusts the volume (not shown). The A/D converter 52 converts a sound signal from the amplifier 51 from an analog signal into a digital signal. The adaptive echo subtracter 53 includes a digital signal processor (DSP), for example, and performs a process of suppressing an echo component which is a noise component due to the sound output from the speaker 32, for the signal input from the A/D converter 52.

The sound codec section 54 performs a process of converting the sound signal input from the microphone 33 into a code determined in the television conference system 1, that is, an encoding process so as to transmit the input sound signal to the second information processing device 12 through the communication line 13. Further, the sound codec section 54 performs a process of decoding the code transmitted to the first information processing device 11 from the second information processing device 12 through the communication line 13.

The D/A converter 56 converts the sound signal supplied from the sound codec section 54 from the digital signal to the analog signal. The amplifier 57 amplifies the analog sound signal output from the D/A converter 56. The amplification factor of the amplifier 57 may be set and changed to an arbitrary value as the user adjusts the volume (not shown). The speaker 32 outputs a sound based on the sound signal amplified by the amplifier 57.

The second information processing device 12 is configured in a similar way to the first information processing device 11. That is, the second information processing device 12 includes a far end device 71, a speaker 72, and a microphone 73. Further, although not shown, in a similar way to the near end device 31, the far end device 71 includes an amplifier, an A/D converter, an adaptive echo subtracter, a sound codec section, a communication section, a D/A converter, and an amplifier.

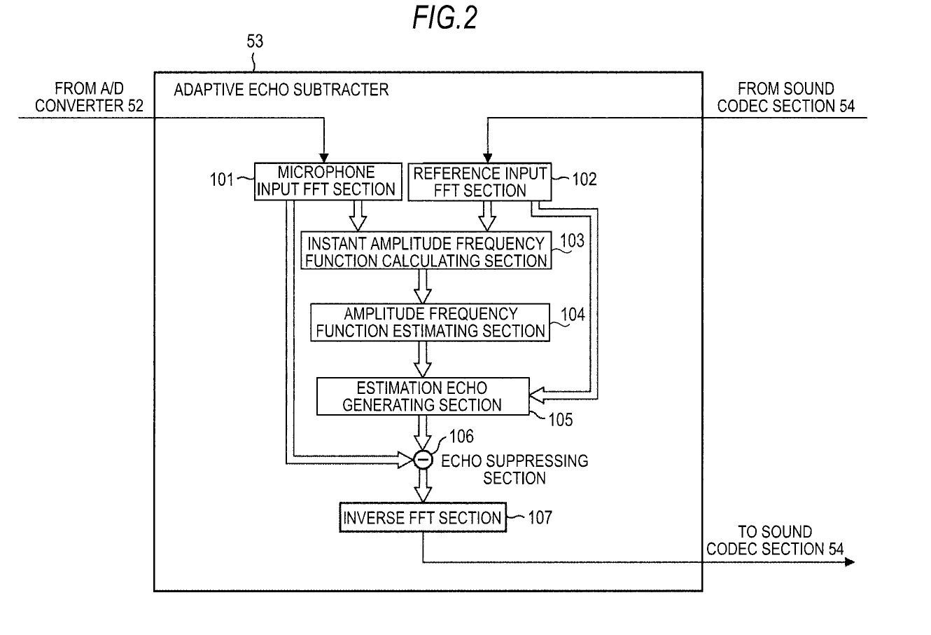

FIG. 2 is a block diagram illustrating a configuration of the adaptive echo subtracter 53. The adaptive echo subtracter 53 includes a microphone input FFT (Fast Fourier Transform) section 101, a reference input FFT section 102, an instant amplitude frequency function calculating section 103, an amplitude frequency function estimating section 104, an estimation echo generating section 105, an echo suppressing section 106, and an inverse FFT section 107.

The microphone input FFT section 101 converts a sound signal input from the A/D converter 52 into a signal in a frequency domain by FFT, and then performs bandwidth division in the unit of predetermined frequency. The reference input FFT section 102 converts a sound signal input from the sound codec section 54 into a signal in a frequency domain by FFT, and then performs bandwidth division in the unit of predetermined frequency. The instant amplitude frequency function calculating section 103 divides an instant microphone input signal from the microphone input FFT section 101 for each frequency band by an instant speaker output signal from the reference input FFT section 102 for each frequency band, to calculate an instant amplitude frequency function. The amplitude frequency function is a characteristic indicating the magnitude of the amplitude of a signal of each frequency.

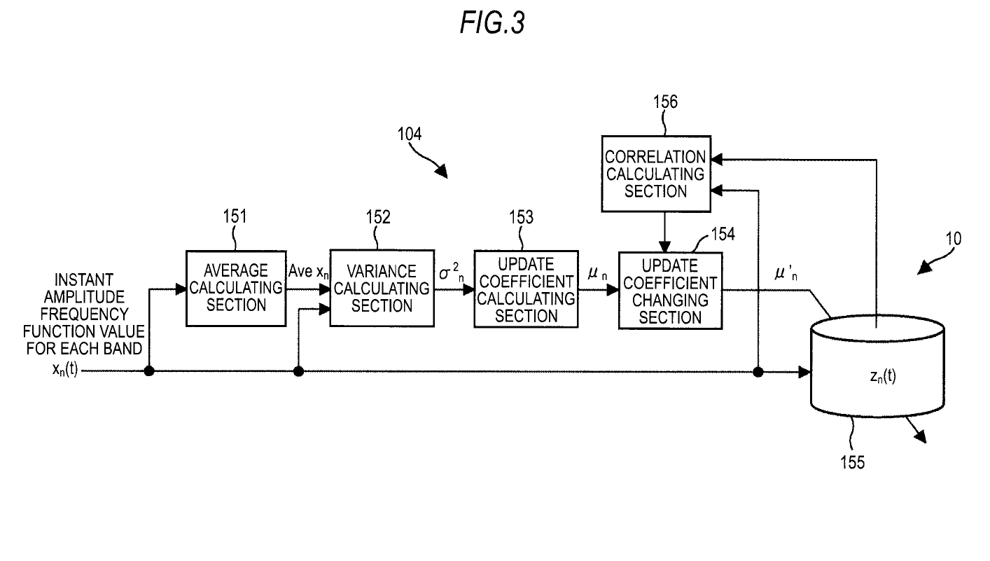

The amplitude frequency function estimating section 104 estimates an amplitude frequency function on the basis of the instant amplitude frequency function input from the instant amplitude frequency calculating section 103. Details about the amplitude frequency function estimating section 104 will be described later with reference to FIG. 3. The estimation echo generating section 105 generates an estimated echo signal from the estimated amplitude frequency function generated by the amplitude frequency function estimating section 104 and the instant speaker output signal converted into the frequency domain by the reference input FFT section 102.

The echo suppressing section 106 subtracts the estimated echo signal generated by the estimation echo generating section 105 from the microphone input frequency data output from the microphone input FFT section 101, to generate an echo-suppressed signal in which an echo component is suppressed. The inverse FFT section 107 converts the echo-suppressed signal output from the echo suppressing section 106 into an echo-suppressed signal in a time domain, and then outputs the signal to the sound codec section 54.

FIG. 3 is a block diagram illustrating a configuration of the amplitude frequency function estimating section 104. The amplitude frequency function estimating section 104 includes an average calculating section 151, a variance calculating section 152, an update coefficient calculating section 153, an update coefficient changing section 154, a storage section 155 and a correlation calculating section 156.

The average calculating section 151 calculates an average of the instant amplitude frequency function for each band input from the instant amplitude frequency function calculating section 103. The variance calculating section 152 calculates a variance for each band, on the basis of the instant amplitude frequency function input from the instant amplitude frequency function calculating section 103 and the average value input from the average calculating section 151. The update coefficient calculating section 153 calculates an update coefficient for each band, on the basis of the variance output from the variance calculating section 152. The update coefficient changing section 154 changes the update coefficient for each band calculated by the update coefficient calculating section 153 on the basis of the correlation calculated by the correlation calculating section 156, and then outputs the result to the storage section 155.

The storage section 155 calculates and stores the estimated amplitude frequency function for each band, using the changed update coefficient which is output from the update coefficient changing section 154 and the instant amplitude frequency function for each band which is input from the instant amplitude frequency function calculating section 103. The correlation calculating section 156 calculates the correlation between the instant amplitude frequency function in the entire band input from the instant amplitude frequency function calculating section 103 and the estimated amplitude frequency function in the entire band supplied from the storage section 155.

### <2. Operation of Information Processing System>

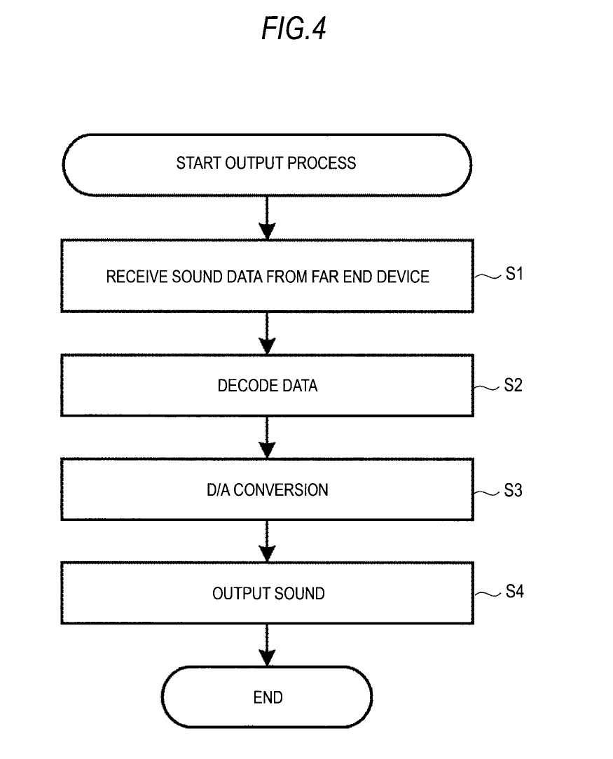

Next, an operation of the information processing system 1 will be described with reference to FIGS. 4 to 6.

Firstly, an output process of the first information processing device 11 will be described with reference to FIG. 4. FIG. 4 is a flowchart illustrating the output process of the first information processing device.

In step S1, the communication section 55 of the first information processing device 11 receives sound data from the far end device 71 of the second information processing device 12. That is, in a case where a sound signal of a user of the second information processing device 12 is obtained by the microphone 73 and is transmitted through the communication line 13, the communication section 55 receives the sound signal. In step S2, the sound codec section 54 decodes the data. That is, the sound codec section 54 decodes the sound data received by the communication section 55 in step S1. The decoded sound data is supplied to the D/A converter 56 and is supplied to the adaptive echo subtracter 53.

In step S3, the D/A converter 56 converts the sound data decoded by the sound codec section 54 into an analog signal. In step S4, the speaker 32 outputs the sound. That is, the sound signal which is D/A converted by the D/A converter 56 is amplified by the amplifier 57, and then, the corresponding sound, that is, the sound of the user of the second information processing device 12 is output from the speaker 32.

A user of the first information processing device 11 hears the sound of the user of the second information processing device 12 and utters a sound in replay.

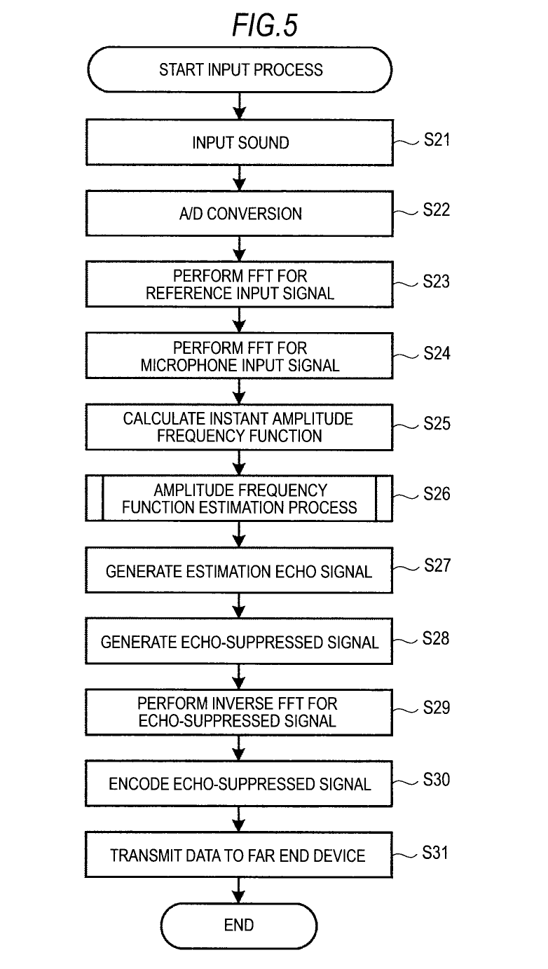

Next, an operation of inputting the sound will be described. FIG. 5 is a flowchart illustrating an input process of the first information processing device 11.

In step S21, the microphone 33 receives the sound as an input. That is, the sound which is uttered by the user of the first information processing device 11 in response to the sound of the user of the second information processing device 12 is collected by the microphone 33. Here, the sound transmitted from the first information processing device 12, which is output from the speaker 32, that is, an echo component may be input to the microphone 33. If the echo component is transmitted to the second information processing device 12 as it is, the user of the second information processing device 12 hears the sound with a little delay which is uttered by the user himself as an echo from the speaker 72 of the user himself, and thus, the so-called echo phenomenon occurs.

In step S22, the A/D converter 52 A/D-converts the input sound signal. That is, the sound signal input to the microphone 33 in step S21 is amplified by the amplifier 51, is converted from the analog signal into the digital signal by the A/D converter 52, and then is input to the adaptive echo subtracter 53.

In step S23, the reference input FFT section 102 performs FFT for a reference input signal. That is, the sound data of the user of the second information processing device 12, which is input from the sound codec section 54 in step S2 in FIG. 4, is subject to FFT, and then is converted into sound data in a frequency domain for each frequency band. In step S24, the microphone input FFT section 101 performs FFT for a microphone input signal. That is, in step S22, the sound data of the user of the first information processing device 11, which is supplied from the A/D converter 52, is subject to FFT, and then is converted into sound data in a frequency domain for each frequency band.

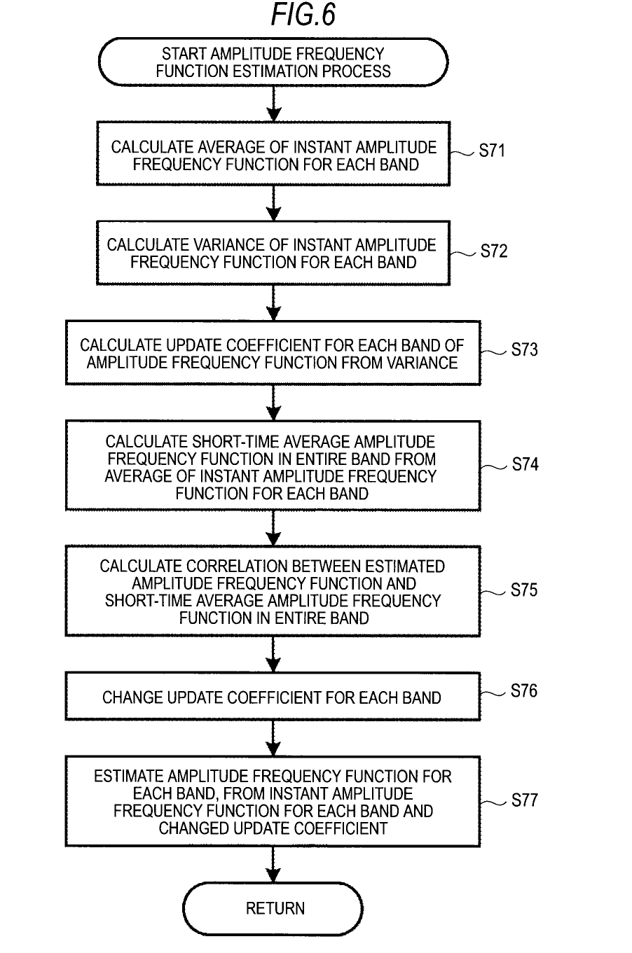

In step S25, the instant amplitude frequency function calculating section 103 calculates an instant amplitude frequency function. Specifically, the instant microphone input signal which is calculated in step S24 is divided by an instant speaker output signal which is calculated in step S23, to thereby calculate the instant amplitude frequency function. Next, in step S26, the amplitude frequency function estimating section 104 performs an amplitude frequency function estimation process. Details about the amplitude frequency function estimation process are shown in FIG. 6. Here, the amplitude frequency function estimation process will be described with reference to FIG. 6.

FIG. 6 is a flowchart illustrating the amplitude frequency function estimation process. In step S71, the average calculating section 151 calculates an average of the instant amplitude frequency function for each band. For example, an average value Ave xₙ of a value xₙ(t) of the instant amplitude frequency function in a band n at a time t is calculated by the following formula.

$${Avex}_{n} = \frac{1}{N} {\sum }_{i = 0}^{N - 1} {x}_{n} ( t - i ) \qquad ( 1 )$$

In step S72, the variance calculating section 152 calculates a variance of the instant amplitude frequency function for each band, on the basis of the average value Ave xₙ calculated by the average calculating section 151 in step S72 and the value xₙ(t) of the instant amplitude frequency function in the band n at the time t. Specifically, a variance value σ²ₙof the value xₙ(t) of the instant amplitude frequency function in the band n at the time t is calculated by the following formula.

$${σ}_{n}^{2} = \frac{1}{N} {\sum }_{i = 0}^{N - 1} {\{ {x}_{n} ( t - i ) - {Avex}_{n} \}}^{2} \qquad ( 2 )$$

Instep S73, the update coefficient calculating section 153 calculates an update coefficient for each band of the amplitude frequency function from the variance calculated in step S72. An update coefficient μₙ of the band n is expressed by the following formula.

μₙ=f(σₙ) (3)

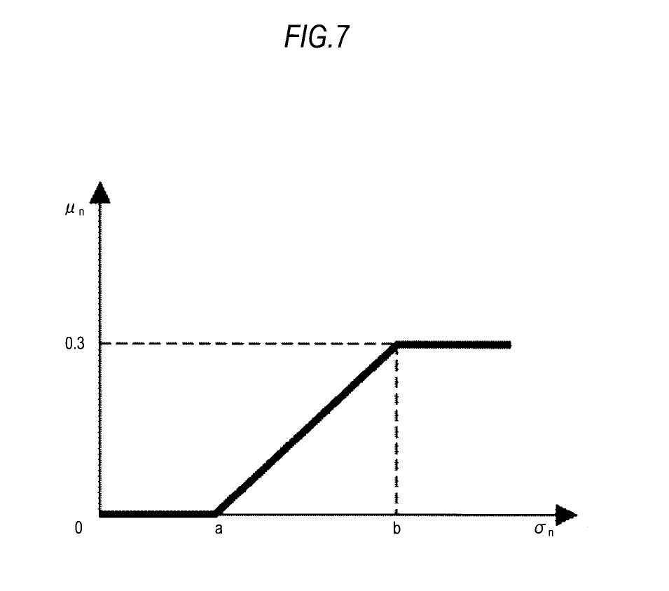

FIG. 7 is a diagram illustrating a specific example of the update coefficient μₙ. In this example, the update coefficient ηₙ is 0 when the value of σₙ is 0 to a, and is 0.3 when the value of σₙ is b or more. Further, when the value of aₙ is a to b, the update coefficient μₙ is linearly increased from 0 to 0.3 in proportion to the value of σₙ.

In step S74, the correlation calculating section 156 calculates a short-time average amplitude frequency function in the entire band, from the average of the instant amplitude frequency function for each band calculated in step S71. In step S75, the correlation calculating section 156 calculates the correlation between the estimated amplitude frequency function and the short-time average amplitude frequency function in the entire band. The estimated amplitude frequency function is previously calculated in step S77, and the short-time average amplitude frequency function in the entire band is calculated in step S74.

In step S76, the update coefficient changing section 154 changes the update coefficient μₙ for each band. A changed update coefficient is set to μ′ₙ. In a case where the correlation value calculated in step S75 has a size which is equal to or larger than a predetermined threshold value which is determined in advance, that is, in a case where the correlation is high, the update coefficient μₙ for each band is changed into a changed update coefficient α (constant value) which is determined in advance. On the other hand, in a case where the correlation value has a size which is smaller than the threshold value, that is, in a case where the correlation is low, the changed update coefficient μ′ₙis set to the update coefficient μₙ as it is (μ′ₙ=μₙ).

In step S77, the storage section 155 estimates the amplitude frequency function for each band, on the basis of the instant amplitude frequency function for each band and the changed update coefficient. The estimated amplitude frequency function is stored in the storage section 155. The instant amplitude frequency function for each band is a value calculated in step S25 of FIG. 5, and the changed update coefficient is a value μₙ(=α or μₙ) changed instep S76. The estimated amplitude frequency function Zₙ(t) of the band n is expressed by the following formula.

Zₙ(t)=(1−μₙ)×Zₙ(t−1)+μₙ×Xₙ(t) (4)

Zₙ(t−1) in formula (4) is the estimated amplitude frequency function stored in the storage section 155 in the previous process.

Returning to FIG. 5, after the amplitude frequency function estimation process is performed as described above in step S26, the estimation echo generating section 105 generates an estimated echo signal in step S27. Specifically, the estimated amplitude frequency function generated in step S77 is multiplied by the instant speaker output signal output from the reference input FFT section 102, to thereby generate an estimated echo signal corresponding to the echo signal.

In step S28, the echo suppressing section 106 generates an echo-suppressed signal. That is, the estimated echo signal generated by the estimation echo generating section 105 instep S27 is subtracted from the instant microphone input signal output from the microphone input FFT section 101. As the estimated echo signal corresponding to the echo signal is subtracted from the instant microphone input signal, a signal in which an echo component is suppressed is obtained.

In step S29, the inverse FFT section 107 performs an inverse FFT for the echo-suppressed signal. Thus, an echo-suppressed signal in a time domain is obtained. The echo-suppressed signal is supplied to the sound codec section 54.

In step S30, the sound codec section 54 encodes the echo-suppressed signal. In step S31, the communication section 55 transmits data to the far end device 71. That is, the encoded echo-suppressed data is transmitted to the second information processing device 12 through the communication line 13.

In the information processing device 12, the same processes as the output process and the input process in the above-described first information processing device 11 are performed.

<3. Conceptual Description about Operation>

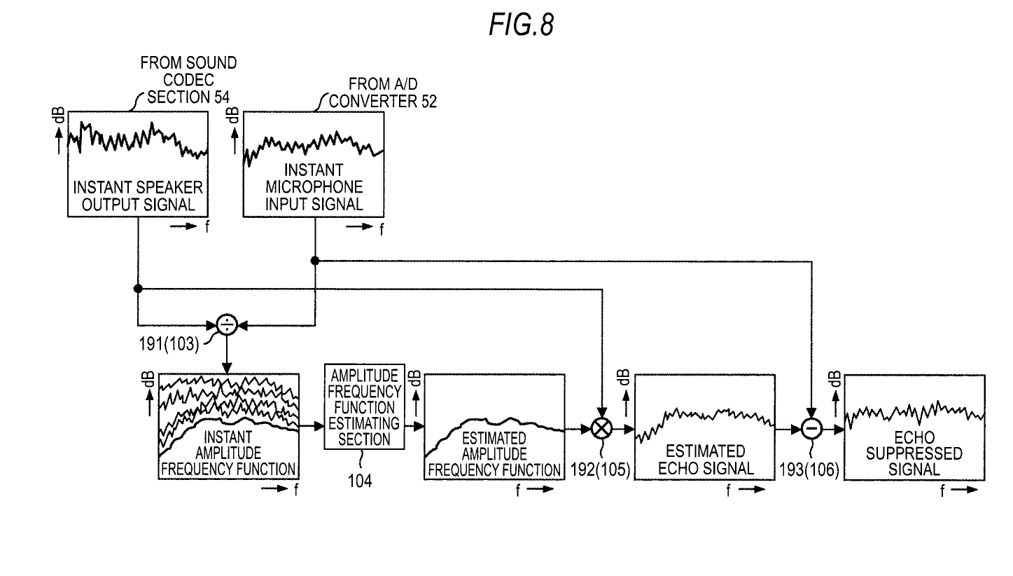

Next, the concept of the above-mentioned operation will be described. FIG. 8 is a diagram schematically illustrating the operation of the information processing system 1. As shown in the figure, in a divider 191 which corresponds to the instant amplitude frequency function calculating section 103, the instant microphone input signal output from the A/D converter 52 is divided by the instant speaker output signal output from the sound codec section 54. Thus, the instant amplitude frequency function is obtained.

The amplitude frequency function estimating section 104 estimates the estimated amplitude frequency function from the instant amplitude frequency function. A multiplier 192 which forms the estimation echo generating section 105 multiplies the speaker output signal and the estimated amplitude frequency function together, to thereby generate the estimated echo signal. A subtracter 193 which forms the echo suppressing section 106 subtracts the estimated echo signal from the instant microphone input signal, to thereby generate the echo-suppressed signal.

Since the echo-suppressed signal is transmitted to the device of the other party in this way, the user of the device of the other party can reliably hear the utterance of the counter party without being disturbed by the utterance of the user himself.

For example, in a case where the user adjusts the volume of the amplifier 57 or the amplifier 51 to change the amplification factor, the instant amplitude frequency function is changed. Here, since the above-mentioned process is repeated in real time, a new coefficient is learned and the learned coefficient is set. Accordingly, it is possible to suppress the echo component even though the amplification factor is changed.

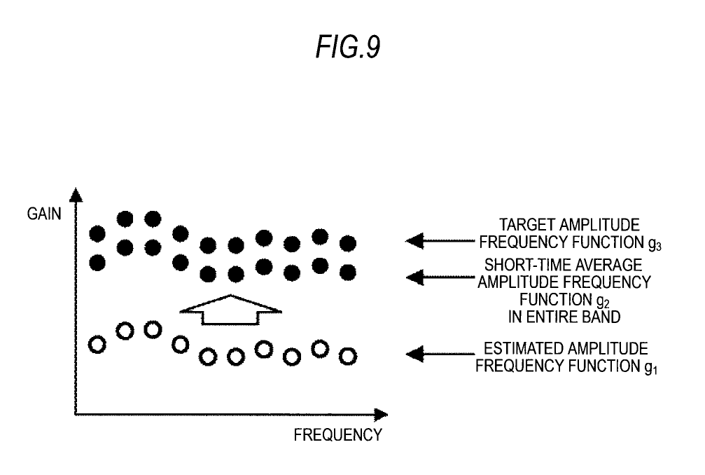

FIG. 9 is a diagram schematically illustrating the operation of the information processing system 1. As shown in the figure, it is assumed that there is a characteristic that an estimated amplitude frequency function before volume change is indicated as g₁. By changing the amplification factor, it is assumed that a characteristic indicated as g₃ is set as a target amplitude frequency function after volume change. In this case, if the correlation between the estimated amplitude frequency function g₁ and the target amplitude frequency function g₃ is high, as described above, the changed update coefficient μ′ₙ is set to the constant value α. As a result, when the characteristic is gradually changed from the estimated amplitude frequency function g₁ to the target amplitude frequency function g₃, a short-time average amplitude frequency function g₂ in the entire band during transition has a gain in each frequency band which is changed by the same value, and thus rapidly converges on the characteristic of the target amplitude frequency function g₃.

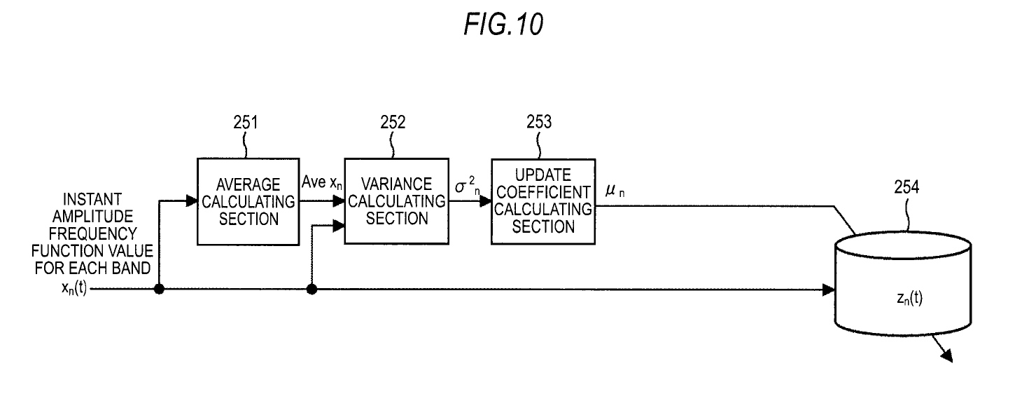

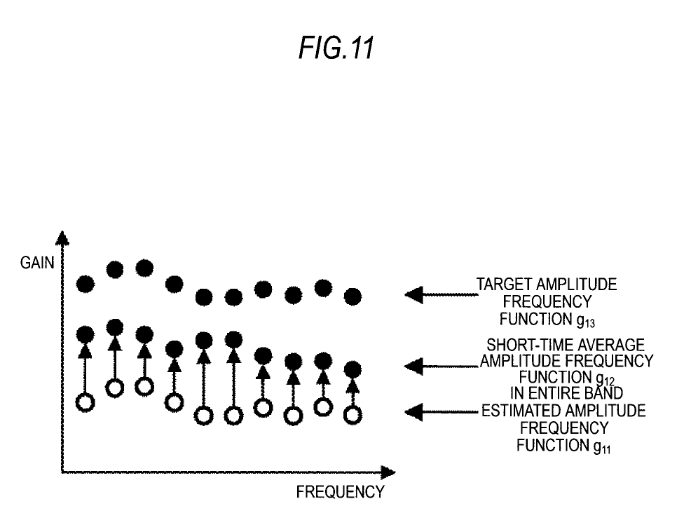

Here, for comparison, as the amplitude frequency function estimating section 104, a different configuration may be considered. FIG. 10 is a block diagram illustrating a compared configuration of the amplitude frequency function estimating section 104. In this configuration example, an average calculating section 251, a variance calculating section 252, an update coefficient calculating section 253 and a storage section 254 are provided corresponding to the average calculating section 151, the variance calculating section 152, the update coefficient calculating section 153, and the storage section 155 shown in FIG. 3. However, a configuration corresponding to the update coefficient changing section 154 and the correlation calculating section 156 is not provided. That is, in this configuration, the coefficient is not updated on the basis of the correlation. As a result, in a case where the amplification factor is changed, the amplitude frequency function during transition is as shown in FIG. 11.

FIG. 11 is a diagram schematically illustrating the operation of a compared information processing system 1. As shown in the figure, it is assumed that there is a characteristic that an estimated amplitude frequency function before volume change is indicated as g₁₁. By changing the amplification factor, it is assumed that a characteristic indicated as g₁₃ is set as a target amplitude frequency function after volume change. In this case, when the characteristic is changed from the estimated amplitude frequency function g₁₁ to the target amplitude frequency function g₁₃, a short-time average amplitude frequency function g₁₂ in the entire band during transition has a gain in each frequency band which is changed by different values. As a result, it takes a longtime to converge the characteristic of the target amplitude frequency function g₁₃.

The information processing system 1 is not limited to the television conference system 1, and may be applied to a system such as a hands-free telephone system or a monitoring camera system, or a device which performs sound recognition while reproducing a car stereo system.

### <4. Application of the Present Disclosure to Program>

The above-described series of processes maybe performed by hardware or software. In a case where the series of processes are performed by software, a program which forms the software is installed in a computer. Here, the computer includes a computer installed in dedicated hardware, or a general purpose personal computer capable of performing various functions by having various programs installed, for example.

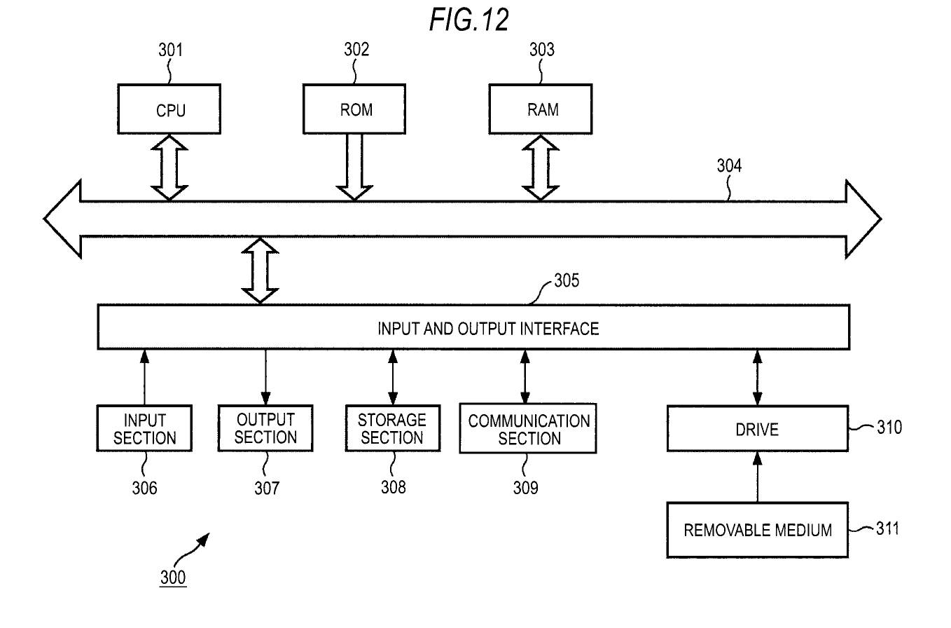

FIG. 12 is a block diagram illustrating a configuration example of hardware of a computer 300 which performs the above-described series of processes by a program.

In the computer 300, a CPU (Central Processing Unit) 301, a ROM (Read Only Memory) 302, and a RAM (Random Access Memory) 303 are connected to each other by a bus 304.

An input and output interface 305 is connected to the bus 304. An input section 306, an output section 307, a storage section 308, a communication section 309 and a drive 310 are connected to the input and output interface 305.

The input section 306 includes a keyboard, a mouse, a microphone or the like. The output section 307 includes a display, a speaker or the like. The storage section 308 includes a hard disk, a non-volatile memory, or the like. The communication section 309 includes a network interface or the like. The driver 310 drives a removable medium 311 such as a magnetic disk, an optical disc, a magneto-optical disc or a semiconductor memory.

In the computer having such a configuration, for example, the CPU 301 loads the program stored in the storage section 308 on the RAM 303 through the input and output interface 305 and the bus 304 to be executed, and thus, the above-described series of processes are performed.

In the computer, for example, the program may be installed in the storage section 308 through the input and output interface 305 by installing the removable medium 311 which is a package medium or the like in the drive 310. Further, the program may be received by the communication section 309 through a wired or wireless transmission medium, and may be installed in the storage section 308. Further, the program maybe installed in advance in the ROM 302 or the storage section 308.

The program which is executed by the computer may be a program of which the processes are performed in a time series manner along the order described in this specification, or may be a program of which the processes are performed in parallel or at a necessary timing such as a call.

Further, in this specification, the system represents the entire configuration including a plurality of devices.

The embodiment of the present disclosure is not limited to the above-described embodiment, and various modifications may be made in the range without departing the spirit of the present disclosure.

### <5. Others>

The present disclosure may be implemented as the following configurations.

(1) An information processing device including:

an estimating section which estimates an amplitude frequency function from a first signal output to a speaker and a second signal input from a microphone;

a generating section which generates an estimated echo signal from the first signal and the amplitude frequency function; and

a suppressing section which suppresses the estimated echo signal from the second signal,

wherein the estimating section changes a coefficient of the amplitude frequency function on the basis of the correlation between the estimated amplitude frequency function and a short-time average amplitude frequency function.

(2) The information processing device according to (1),

wherein in a case where the correlation is higher than a threshold value which is determined in advance, the coefficient is changed by a constant value.

(3) The information processing device according to (2),

wherein in a case where the correlation is lower than the threshold value, the coefficient is not changed.

(4) The information processing device according to (1), (2) or (3),

wherein the first signal is a signal in a frequency domain of a signal output to the speaker, and wherein the second signal is a signal in the frequency domain of a signal input from the microphone.

(5) The information processing device according to any one of (1) to (4), further including:

a calculating section which calculates an instant amplitude frequency function from the first signal and the second signal in the frequency domain,

wherein the estimating section estimates the amplitude frequency function from the instant amplitude frequency function.

(6) The information processing device according to any one of (1) to (5),

wherein the second signal in the frequency domain, in which the estimated echo signal is suppressed, is converted into a signal in a time domain.

(7) An information processing method including:

estimating an amplitude frequency function from a first signal output to a speaker and a second signal input from a microphone;

generating an estimated echo signal from the first signal and the amplitude frequency function; and

suppressing the estimated echo signal from the second signal,

wherein in the estimating of the amplitude frequency function, a coefficient of the amplitude frequency function is changed on the basis of the correlation between the estimated amplitude frequency function and a short-time average amplitude frequency function.

(8) A program which causes a computer to execute a routine including:

estimating an amplitude frequency function from a first signal output to a speaker and a second signal input from a microphone;

generating an estimated echo signal from the first signal and the amplitude frequency function; and suppressing the estimated echo signal from the second signal,

wherein in the estimating of the amplitude frequency function, a coefficient of the amplitude frequency function is changed on the basis of the correlation between the estimated amplitude frequency function and a short-time average amplitude frequency function.

The present disclosure contains subject matter related to that disclosed in Japanese Priority Patent Application JP 2011-177568 filed in the Japan Patent Office on Aug. 15, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
an estimating section which estimates an amplitude frequency function from a first signal output to a speaker and a second signal input from a microphone;
a generating section which generates an estimated echo signal from the first signal and the amplitude frequency function; and
a suppressing section which suppresses the estimated echo signal from the second signal,
wherein the estimating section changes a coefficient of the amplitude frequency function on the basis of the correlation between the estimated amplitude frequency function and a short-time average amplitude frequency function.

2. The information processing device according to claim 1,
wherein in a case where the correlation is higher than a threshold value which is determined in advance, the coefficient is changed by a constant value.

3. The information processing device according to claim 2,
wherein in a case where the correlation is lower than the threshold value, the coefficient is not changed.

4. The information processing device according to claim 3,
wherein the first signal is a signal in a frequency domain of a signal output to the speaker, and
wherein the second signal is a signal in the frequency domain of a signal input from the microphone.

5. The information processing device according to claim 4, further comprising:
a calculating section which calculates an instant amplitude frequency function from the first signal and the second signal in the frequency domain,
wherein the estimating section estimates the amplitude frequency function from the instant amplitude frequency function.

6. The information processing device according to claim 5,
wherein the second signal in the frequency domain, in which the estimated echo signal is suppressed, is converted into a signal in a time domain.

7. An information processing method comprising:
estimating an amplitude frequency function from a first signal output to a speaker and a second signal input from a microphone;
generating an estimated echo signal from the first signal and the amplitude frequency function; and
suppressing the estimated echo signal from the second signal,
wherein in the estimating of the amplitude frequency function, a coefficient of the amplitude frequency function is changed on the basis of the correlation between the estimated amplitude frequency function and a short-time average amplitude frequency function.

8. A program which causes a computer to execute a process comprising:
estimating an amplitude frequency function from a first signal output to a speaker and a second signal input from a microphone;
generating an estimated echo signal from the first signal and the amplitude frequency function; and
suppressing the estimated echo signal from the second signal,
wherein in the estimating of the amplitude frequency function, a coefficient of the amplitude frequency function is changed on the basis of the correlation between the estimated amplitude frequency function and a short-time average amplitude frequency function.
